(19) United States
(12) Patent Application Publication
(10) Pub. No.: US 2026/0017467 A1
(43) Pub. Date: Jan. 15, 2026

(54) NATURAL LANGUAGE PROCESSING OF SYNTHETIC DESCRIPTIONS

(71) Applicant: Valassis Digital Corp., San Antonio, TX (US)

(72) Inventors: Paul Matthew Gurniak, Portland, ME (US); Gavin Matthew Litchfield, Raleigh, NC (US); Michael Vincent Bonadio, Lakeland, FL (US); Justin Lim, Ann Arbor, MI (US); Rebecca Joy Witmer, San Antonio, TX (US); Miles Stafford Richardson, Morrisville, NC (US)

(21) Appl. No.: 19/265,184

(22) Filed: Jul. 10, 2025

Related U.S. Application Data
(60) Provisional application No. 63/669,989, filed on Jul. 11, 2024.

(51) Int. Cl. G06F 40/40; G06F 40/279

(52) U.S. Cl. CPC G06F 40/40; G06F 40/279

(57) ABSTRACT

Content is identified based on natural language processing. A data object comprising a freeform text description of desired content is received. Supplementary data objects comprising other freeform text data representing of the desired content are created using a language model. The data object and the supplementary data objects are embedded into a vector space using a second language model. From a plurality of potential content objects, selected content objects are selected based on distances in the vector space between i) the selected content objects and ii) at least one of the data object and the supplementary data objects.

### CLAIM OF PRIORITY

This application claims priority to U.S. Application Ser. No. 63/669,989, filed on Jul. 11, 2024, the entire contents of which are hereby incorporated by reference.

### TECHNICAL FIELD

This document relates to natural language processing.

### BACKGROUND

Computers can use natural language processing to process data encoded in natural language, typically collected in text corpora, using either rule-based, statistical or neural-based approaches of machine learning and deep learning. Major tasks in natural language processing include speech recognition, text classification, natural-language understanding, and natural-language generation.

### SUMMARY

This document describes technology for performing contextual targeting on digital ad campaigns. The system is able to find content for ad placements using an arbitrarily specific plain-language description from a user (for example: “fruit pie recipes”) and place ads alongside that content. This system can use generative AI (a Large Language Model or LLM) to create examples of content matching the user's description. It also uses a different, smaller language model (which can be run at scale) to generate representative content embeddings for both the example desired content and each piece of real content available for ad placements. These embeddings are compared to identify desirable, relevant ad placements for the campaign.

Implementations can include any, all, or none of the following features.

This technology can be configured to use generative AI (LLM) to create artificial examples of the desired content. This technology can use a language model to generate content embeddings to identify real content that is similar to the AI-generated examples. This technology can apply this specifically to selecting desirable ad placements.

This technology can be more flexible than alternatives that use content taxonomy. For example, content taxonomies may only provide a pre-defined list of options. Users are limited to these choices, and cannot specify something other than these options for targeting (for example: something more specific). Users must be familiar enough with the taxonomy to find the categories closest to what they want.

This technology allows users with no prior knowledge to specify any type of content. This may fall outside of any content taxonomy (such as referencing a specific recent event in the news), and can be arbitrarily broad or specific depending on the ad buyer's targeting interests.

This technology can be more accurate than alternatives that use keywords. Using keywords to find relevant content can be difficult. Keywords can also match words with different meanings than what the user intended. For example, an ad buyer working on behalf of a construction company trying to find homeowners interested in building a new fence might enter “fencing” as a keyword. However, “fencing” may also be referring to the sport of fencing and matches against that keyword would be poor (less relevant) ad placements for their product.

Keywords will match regardless of how important the phrase is to the content. For example, a news article about a local diner closing down might contain a quote from a former customer describing how much they liked the “apple pie recipe” the diner used. This news article would be a poor ad placement for someone looking for content containing actual recipes for fruit pies.

By using a language model to generate content embeddings (e.g., attention weights between tokens to capture the in-context meanings), this technology is able to correctly recognize the in-context meaning of each word. Content about “fencing” (a yard) and “fencing” (the sport) will have very different embeddings.

In addition, by generating an embedding for the entire content, the technology is able to represent it holistically. A news article that coincidentally mentions “apple pie recipe” will have a content embedding vector that is similar to news articles, not recipes.

This technology can require less manual effort than alternatives using keywords. For example, using keywords can require the user to spend time coming up with a list of varied phrases. If the user wants “fruit pie recipes”, they can simply enter that into the technology to find relevant content. When targeting with keywords, they would need to manually come up with the many variations on the phrase that will actually appear in content (“apple pie”, “apple pie recipe”, “key-lime pie”, “key lime pie” with no hyphen, “strawberry-rhubarb pie”, “best fruit pies”, etc.).

This technology can be more robust to user error than alternatives using keywords. For example, user mistakes, such as typos in keywords or entering extraneous phrases, can have significant adverse effects on the relevance of ad placements for the campaign. For example, if an ad buyer trying to sell HYSAs (High-Yield Savings Account) accidentally enters “HSYA” as a keyword, they may find very few ad placements, or ad placements that do not match the content they are looking for. If a user accidentally pasted in “etc.” at the end when copying in a long list of relevant keywords when setting up an ad campaign, that specific keyword may inadvertently match a lot of irrelevant content. The large language models the technology uses to generate example content are robust to some user errors. For example, if a user asks for “checking accounts and HSYAs”, the language model understands the intent and will correct the typo in the generated example. The example of “etc.” may influence the language model to generate more varied content, but the results would still be relevant to the other elements of the user's description.

This technology can be used for content placement for various types of documents. For example, this technology can be used to provide advertisements, related stores, and related social media posts. This technology can be implemented to place the content into websites, computer or phone applications, television commercials, and other document types.

This technology can be used to identify very specific content objects. For example, very large corpuses of content objects (e.g., the entire World Wide Web, all posts on a social media website or encyclopedia, chat logs of public discussion in a long-running multi-player video game) can include content directed to very niche interests, and the intersections of multiple niche interests. This technology is able to identify those very niche interests and niche intersections with greater accuracy than other systems that do not leverage the same type of context analysis.

This technology can be used to avoid finding documents that may seem to be of a related context, but that should be excluded for various reasons. For example, a publisher of a position on one side of a disagreement or polarizing topic may with only to find content objects that agree (or disagree) with their position. While a more simplistic alternative may be unable to discern between the two sides of a topic and only identify that a content object is related to the topic, this technology can advantageously block and/or detarget content objects that are associated with the topic, but on the other side of the topic.

This technology provides efficient analysis of content objects that can advantageously be used in different down-stream technologies. For example, a media platform may use the subtitle information of videos to identify other related videos and present the related videos as a suggested next-watch for a viewer. A news-reading article can search out more-detailed versions a short news article, find articles on a similar topic published in the past to provide context, or look for a news article on a similar topic but that takes a different side of the topic to provide the reader with a more balanced reading experience. A retailer can find related products to show to a shopper, which may be particularly advantageous to consumers of very niche products. For example, many consumers may be interested in footwear that is inexpensive, attractive, and well made. But some aficionados may instead be very interested in vintage basketball sneakers from the 1980. These users may attempt to browse only for footwear that is i) replica (i.e., not counterfeit), ii) basketball sneakers (i.e., not running shoes or cross trainers), and iii) from the 1980's (i.e., not from the 1970's or 1990's), and this technology can be used to find listings that fit all these criteria without requiring the user to type, or even realize, that is the context that can be searched for.

Other features, aspects and potential advantages will be apparent from the accompanying description and figures.

### DESCRIPTION OF DRAWINGS

FIG. 1 shows a process for identifying content using natural language queries.

FIG. 2 shows a computer system for managing content with natural language processing.

FIG. 3 shows a schematic diagram that shows an example of a computing device and a mobile computing device.

FIG. 4 shows a schematic diagram that shows an example of a computer system for generating context information.

FIG. 5 shows a process for generating embedding information from content objects.

FIGS. 6A and 6B show processes for generating a seed uniform resource locator (seed URL).

FIG. 7 shows a process for identifying content matching a context.

Like reference symbols in the various drawings indicate like elements

### DETAILED DESCRIPTION

A generative language model uses plain-language descriptions of digital content (ads, webpages, social media posts) to create synthetic examples of content matching the plain-language description. A second, smaller, language model is used to create embeddings of both the example description and the generated descriptions. These embedding are used to identify real content that matches the plain-language description if it has a low distance/high similarity in the embedding space.

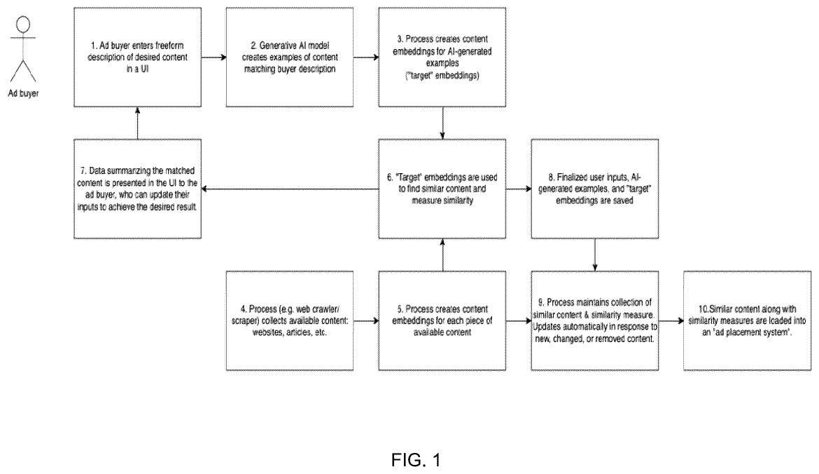

FIG. 1 shows a process for identifying content using natural language queries.

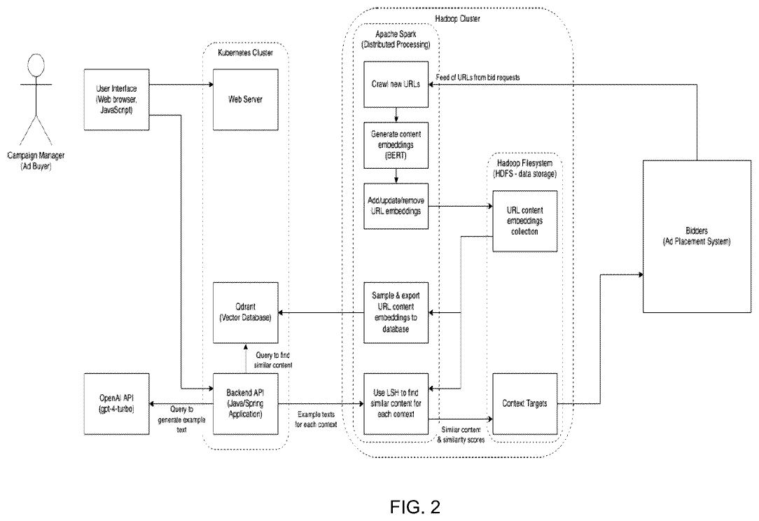

FIG. 2 shows a computer system for managing content with natural language processing.

The ad buyer is able to describe nearly any type of content when creating a context. Compared to prior approaches, they are not limited by a list of available categories in a content taxonomy. For example: an advertiser trying to sell soft drinks to sports fans could enter “pro-football draft news, college-basketball march madness coverage, pro-baseball opening day articles” to find ad placements whose audience is highly likely to be sports fans.

The user may describe multiple related things, which can help expand the number of ad placements found. An advertiser looking for customers to open new checking accounts could enter “comparison of free checking accounts, HYSAs, CDs, etc.” to find ad placements whose audience may already be in the market for a new account.

The system has robustness to things like typos (such as entering “HSYAs” instead of “HYSAs” for High-Yield Savings Accounts) or the user including “etc”. With prior approaches, keywords might get matched exactly, so including typos or extraneous text like “etc” could significantly reduce the relevancy of the resulting ad placements. An advertiser looking to avoid ad placements associated with specific current events that may cause controversy could enter something like: “News articles about conflict in Israel, Palestine, Russia, and Ukraine” In addition to describing desired content for ad placements, the user can also describe content they wish to avoid.

The system can find content relating to specific recent events, even if those are more recent than the training data used by the AI models. The user may also have additional options for what content the system selects, such as setting a “threshold” for the similarity to trade off between quantity & quality of content.

A Generative AI model used to create example content can be a large & complex model. For text, one example for use can include a Large Language Model (LLM) such as GPT-40 accessed using OpenAI's Chat Completions API. As will be understood, use of a more advanced, high-performing model that is capable of generating realistic content can provide more robust results. However, technical limitations and goal may call for a smaller or less complex model.

The system uses a number of “prompting techniques” in order to retrieve a sufficient quality & volume of content for ad placements. For example, the system can generate example content in a variety of forms to find additional placements. For web content, the system prompts the LLM multiple times, each asking for a different medium: news article, blog post, forum discussion, etc.

The system can provide the same prompt multiple times to generate multiple examples of content (the content embeddings would then get combined later when building the “target embedding,” e.g., by averaging them).

The prompt may include additional instructions to improve the suitability of the generated content for advertising purposes. For example, asking for content with a positive sentiment, to help avoid relevant (but potentially negative) ad placements, such as a critical opinion piece on a news website.

Some of these instructions can be based on selections from the user.

“Content embeddings” take the form of a single, high-dimensional vector. If two pieces of content would be considered similar to one another, they should have “similar” (defined later) embedding vectors. For text, it is common for these embeddings to also be generated by providing the content's text to the model, and extracting vectors from the resulting internal state of the model.

Because the “target embeddings” for the generated example content will be compared to real content later, the approach/model used to generate the content embeddings should be the same between the example content generated from user input & the “real” content available for ad placements.

This does not need to be the same model as in section 2 above used to generate content. In our solution, it is not-we use a smaller model for embeddings. Generating the example content requires a much more advanced model, which could be prohibitively expensive to run all available content for ad placements on.

Because the system can provide feedback to the user, there is a benefit to being able to generate embeddings quickly.

This technology can use a transformer model pretrained on a large corpus of English data in a self-supervised fashion (e.g., bert-base-uncased) to generate content embeddings for both the user-generated and crawled web text. The used language model can be capable of identifying the in-context meaning of words in text.

One example process for performing the operations includes:
1) Collect the HTML from a website (as permitted)
2) Process the HTML to extract the visible, on-screen text
3) Clean the text and extract the “head” and “tail” of each page (first 128 and last 384 tokens). In one experiment with web content, this “head” and “tail” approach was found to provide a desirable result, trading off between the number of tokens to process and the quality of the result. When generating embeddings for the AI-generated example content, because the LLM can be used to create text (not HTML), the embedding generation process starts can here with the cleaning.
4) Pass the cleaned/shortened text into a tokenizer to generate inputs for the model.
5) Process the 512-token sequence with the model
6) Extract the “last hidden state” from for each token (this is the last layer of the network before un-embedding). This gives one 768-element vector for each token of input.
7) Take the element-wise average across all processed tokens to create a single 768-element content embedding for that URL.

A model can be chosen based in part on its use of attention weights allowing it to capture the in-context meaning of words/tokens, while also being small enough to run at “web scale”. Using a distributed system (e.g., Apache Spark), can allow for generating content embeddings for all of the content (100s of millions of websites) in a large implementation. In some cases, a context may have more than one example content & resulting content embedding.

Collection and indexing of available content can vary by medium. For example, in one implementation, this technology can be used with ad-supported websites and apps whose ad placements are available for purchase through Real-Time Bidding (RTB). The system described here would also be applicable to other systems that manage ad placements, such as e-commerce websites (where “content” could be product or search result screens). This system operates a “web crawler” that collects the HTML of the web pages we can serve ads on as permitted. The HTML is processed to extract visible text.

The target embeddings are compared with embeddings for available content to retrieve a list of all “similar” content together with a similarity measure or “score” for each.

The approach used to calculate the similarity between two content embeddings can vary. For example, cosine similarity can be used, where higher scores are considered more similar than lower scores.

When searching for content, the system can set a threshold for the minimum similarity that should be retrieved. This setting can be adjusted as needed by either the ad buyer themselves, or an automated process making changes in response to actual results of an advertising campaign. Raising the threshold decreases the quantity but improves relevancy of content. Lowering the threshold increases the quantity, which may be necessary to find more ad placements.

To retrieve similar content across a sufficiently large collection of “available” content (in one case: many websites on the internet), the system must include techniques to optimize retrieval of similar vectors. Computing the similarity measure/score on all content for each target in order to find the most similar is prohibitively expensive in many implementations, and would not be viable for many application of serving ads on internet content. Various approaches can be used to accelerate this process.

When retrieving data for feedback to the user in real-time, the system can use a “vector database” (e.g., Qdrant, Milvus, Pinecone). Vector databases use indexes to significantly reduce the amount of content that must be searched to retrieve the relevant results.

This technology can use a distributed system (e.g., Apache Spark) together with Locality-Sensitive Hashing (LSH) to eliminate most of the content that is not similar to each target vector, and then evaluate the similarity score on the small set of remaining results.

A context might have more than one target embedding vector. This technology currently searches for these targets individually, and takes the union of all results. If a piece of content matches multiple targets, the highest similarity can be used.

To improve the quality of ad placements for the ad buyer, the user interface can present data summarizing the retrieved content. This can include estimates of how much content was retrieved, and how many ad placements (e.g., per day) could be made on this content. This helps the ad buyer make the tradeoff between quantity & quality of content.

Examples of “top scored” content can be provided. This helps the ad buyer determine whether the description they provided would result in a good ad campaign.

Examples of “bottom scored” content (lowest values that are still above the threshold) can be provided. This helps the ad buyer determine whether increases in quantity to find more ad placements could have an undesirable result.

Examples of “highest volume” content: the retrieved results that have the most ad placements available (e.g., highest traffic websites) can be provided.

The user can optionally make changes to their input in response to this feedback. Because the description is in plain language, the user can make additions or clarifications. Such as: adding “NCAA march madness” to “NFL draft news” to find more varied sports content, or removing “HYSAs, CDs” from “comparison of free checking accounts, HYSAs, CDs” because too much content was about investments. The user can change the similarity threshold.

In some implementations, the ad buyer will often be making selections at the beginning of an ad campaign that may run for several months. The set of content that is available for ad placements can change over time: content may be added, removed, or updated. The system can maintain an appropriate list of content for the lifetime of a context or campaign in response to these changes.

Thes lists of content can be maintained and updated by recomputing the result in batch periodically. For example, each hour, Apache Spark can be used to perform an LSH-accelerated comparison of the target embeddings for all active ad campaigns with the collection of embeddings for active web content, and the results are sent to our ad placement system for targeting.

“Ad placement systems” can decide which advertisement(s) are shown when a user views ad-supported content. These placement systems are often responsible for delivering certain outcomes associated with the advertisements, such as a click rate, maximizing revenues, or minimizing costs.

For some implementations, a Demand-Side Platform (DSP) doing Real-Time Bidding (RTB) on opportunities to serve ads on websites, apps, over-the-top video players, etc., can be used. An ad placement system receives “bid requests” from an ad exchanges indicating the opportunity to serve an ad. Each bid request will also indicate the content that ad is appearing within (e.g., the URL of the website the ad would be shown on). For each opportunity, we are competing at auction against other DSPs. Typically, the DSP that places the highest bid for this opportunity will be selected to serve an ad.

The ad placement system can decide choices such as “Would this bid request be a good place to serve an ad from one of our active campaigns?” “If multiple ads/campaigns match, which is best?” and/or “How much are we willing to bid?”

DSP's ad placement system uses the data from each context (collection of similar content & similarity scores), alongside other data, to determine how valuable each bid request is for associated campaigns. This influences decisions of when to bid and how much.

As will be appreciated, this technology can be used in other use cases, including but not limited to finding “ad placements” for things other than websites & RTB. Such as: e-commerce, linear TV

This system could be used to build audiences for extremely specific topics. Such as: customers researching HYSA options. The “audience” could be defined as a list of data related to the devices that viewed or interacted with relevant content.

This system can not only be used to find similar “content”, it can conversely also be leveraged to identify explicit content the user may want to avoid (example: brand safety). The system can be further enhanced to match the sentiment of targeted content. Similar to ad placements this framework can be used for product recommendation by replacing in input to be customer's order history or search parameter and universe to contain embeddings for all products.

Content can include any medium where ads are served to people. For example, this can include websites on the internet (blog posts, news articles, forums, etc.), videos (television channels, over the top streaming, on-demand content, etc.), e-commerce applications (store pages, search results), and/or search engines (search results), social media applications (user feeds, search results).

(Ad) Campaigns can include a set of messages from an advertiser to be distributed (here: displayed alongside other content) to achieve a result (e.g., awareness of a product). Ad campaigns typically specify a range of dates where ads will be shown, as well as the number of times ads will be shown. Ad campaigns often have objectives beyond the number of ads served, including responses from users (e.g., users clicking on the ads).

Context can include the collection of similar content & similarity measures that an ad buyer creates by entering a description in a UI. An ad campaign can use one or more “contexts” to determine where the campaign's ads are shown. For example, the user enters “fruit pie recipes”, which generates a collection of websites with related content (such as: recipes for fruit pies, a forum discussion about favorite fruit pies, dessert recipes including fruits, etc.). An ad campaign using this context would serve ads on those websites.

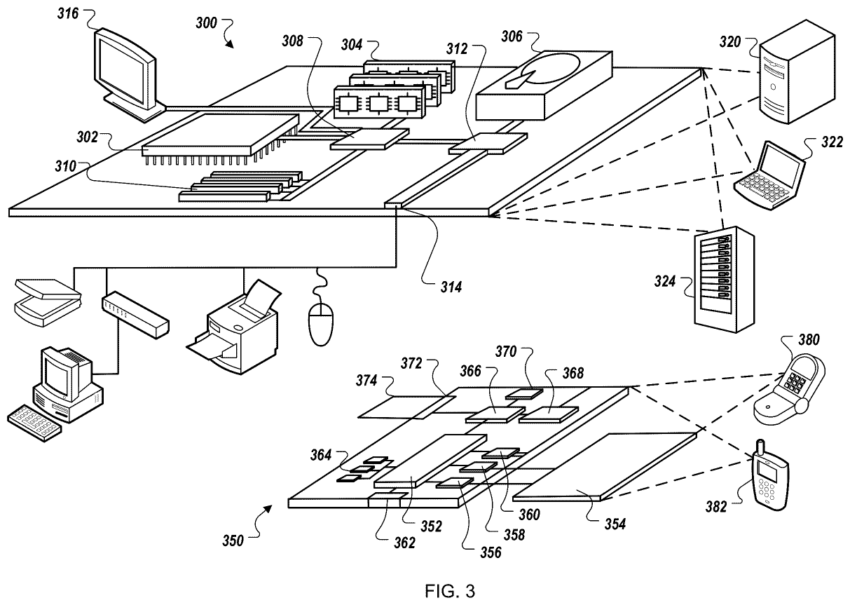

FIG. 3 shows an example of a computing device 300 and an example of a mobile computing device that can be used to implement the techniques described here. The computing device 300 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and can be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 304 stores information within the computing device 300. In some implementations, the memory 304 is a volatile memory unit or units. In some implementations, the memory 304 is a non-volatile memory unit or units. The memory 304 can also be another form of computer-readable medium, such as a magnetic or optical disk.

The storage device 306 is capable of providing mass storage for the computing device 300. In some implementations, the storage device 306 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 304, the storage device 306, or memory on the processor 302.

The high-speed interface 308 manages bandwidth-intensive operations for the computing device 300, while the low-speed interface 312 manages lower bandwidth-intensive operations. Such allocation of functions is exemplary only. In some implementations, the high-speed interface 308 is coupled to the memory 304, the display 316 (e.g., through a graphics processor or accelerator), and to the high-speed expansion ports 310, which can accept various expansion cards (not shown). In the implementation, the low-speed interface 312 is coupled to the storage device 306 and the low-speed expansion port 314. The low-speed expansion port 314, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 300 can be implemented in a number of different forms, as shown in the figure. For example, it can be implemented as a standard server 320, or multiple times in a group of such servers. In addition, it can be implemented in a personal computer such as a laptop computer 322. It can also be implemented as part of a rack server system 324. Alternatively, components from the computing device 300 can be combined with other components in a mobile device (not shown), such as a mobile computing device 350. Each of such devices can contain one or more of the computing device 300 and the mobile computing device 350, and an entire system can be made up of multiple computing devices communicating with each other.

The mobile computing device 350 includes a processor 352, a memory 364, an input/output device such as a display 354, a communication interface 366, and a transceiver 368, among other components. The mobile computing device 350 can also be provided with a storage device, such as a micro-drive or other device, to provide additional storage. Each of the processor 352, the memory 364, the display 354, the communication interface 366, and the transceiver 368, are interconnected using various buses, and several of the components can be mounted on a common motherboard or in other manners as appropriate.

The processor 352 can execute instructions within the mobile computing device 350, including instructions stored in the memory 364. The processor 352 can be implemented as a chipset of chips that include separate and multiple analog and digital processors. The processor 352 can provide, for example, for coordination of the other components of the mobile computing device 350, such as control of user interfaces, applications run by the mobile computing device 350, and wireless communication by the mobile computing device 350.

The processor 352 can communicate with a user through a control interface 358 and a display interface 356 coupled to the display 354. The display 354 can be, for example, a TFT (Thin-Film-Transistor Liquid Crystal Display) display or an OLED (Organic Light Emitting Diode) display, or other appropriate display technology. The display interface 356 can comprise appropriate circuitry for driving the display 354 to present graphical and other information to a user. The control interface 358 can receive commands from a user and convert them for submission to the processor 352. In addition, an external interface 362 can provide communication with the processor 352, so as to enable near area communication of the mobile computing device 350 with other devices. The external interface 362 can provide, for example, for wired communication in some implementations, or for wireless communication in other implementations, and multiple interfaces can also be used.

The memory 364 stores information within the mobile computing device 350. The memory 364 can be implemented as one or more of a computer-readable medium or media, a volatile memory unit or units, or a non-volatile memory unit or units. An expansion memory 374 can also be provided and connected to the mobile computing device 350 through an expansion interface 372, which can include, for example, a SIMM (Single In Line Memory Module) card interface. The expansion memory 374 can provide extra storage space for the mobile computing device 350, or can also store applications or other information for the mobile computing device 350. Specifically, the expansion memory 374 can include instructions to carry out or supplement the processes described above, and can include secure information also. Thus, for example, the expansion memory 374 can be provide as a security module for the mobile computing device 350, and can be programmed with instructions that permit secure use of the mobile computing device 350. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 364, the expansion memory 374, or memory on the processor 352. In some implementations, the computer program product can be received in a propagated signal, for example, over the transceiver 368 or the external interface 362.

The mobile computing device 350 can communicate wirelessly through the communication interface 366, which can include digital signal processing circuitry where necessary. The communication interface 366 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 368 using a radio-frequency. In addition, short-range communication can occur, such as using a Bluetooth, WiFi, or other such transceiver (not shown). In addition, a GPS (Global Positioning System) receiver module 370 can provide additional navigation- and location-related wireless data to the mobile computing device 350, which can be used as appropriate by applications running on the mobile computing device 350.

The mobile computing device 350 can also communicate audibly using an audio codec 360, which can receive spoken information from a user and convert it to usable digital information. The audio codec 360 can likewise generate audible sound for a user, such as through a speaker, e.g., in a handset of the mobile computing device 350. Such sound can include sound from voice telephone calls, can include recorded sound (e.g., voice messages, music files, etc.) and can also include sound generated by applications operating on the mobile computing device 350.

The mobile computing device 350 can be implemented in a number of different forms, as shown in the figure. For example, it can be implemented as a cellular telephone 380. It can also be implemented as part of a smart-phone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other

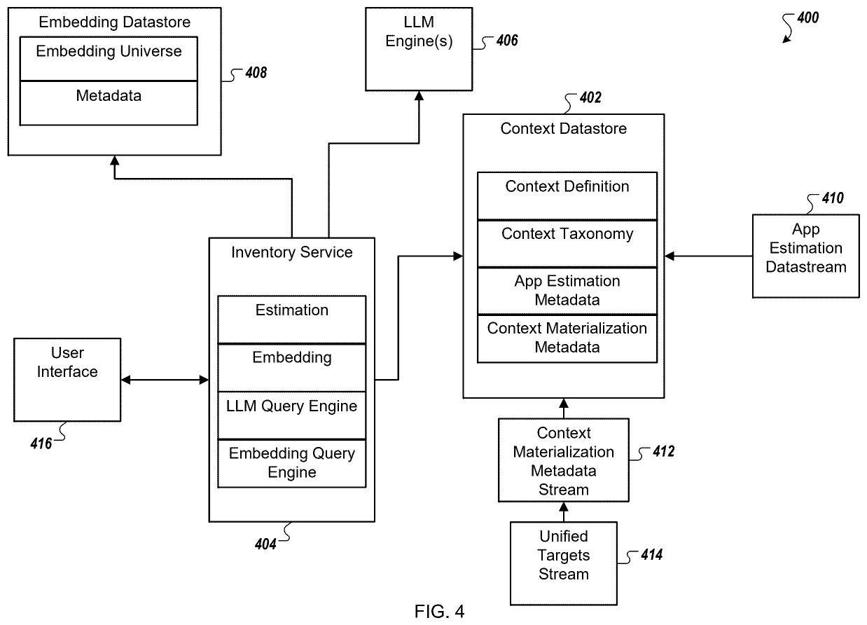

FIG. 4 shows a schematic diagram that shows an example of a computer system 400 for generating context information. For example, the computer system 400 can be hosted on server or networked hardware as previously described, and perform some or all of the operations described in this document.

The computer system 400 can be used to analyze content objects and match them to context information. For example, the computer system 400 can be used to provide mechanisms for a user to get interactive feedback on the types and amount of content that can be found for a given freeform context description.

A context datastore 402 can store information related to contexts. Context definitions of the context datastore 402 can include a list of contexts applicable to one or more document types (e.g., general webpages, social media pages, video game types). These context definitions need not be single key-words, but instead can be human-readable text. This can allow for greater clarity and differentiation between context than would be possible in systems limited only to single key-words. For example, contexts like “high-fashion black dress” and “black-and-white punkwear t-shirts” can be differentiated in the computer system 400. A context taxonomy can arrange the context definitions into one or more taxonomies that define relationships between context definitions. For example, the two contexts ““high-fashion black dress” and “black-and-white punkwear t-shirts” can be organized into a “clothing” category, which may itself be part of a “manufactured goods category. Similarly, “black-and-white punkwear t-shirts” but not “high-fashion black dress” can be associated with a “music” category (e.g., if black-and-white t-shirts are associated with punk fandom).

An inventory service 404 can use information from the context datastore 402 to manage content based on context relations. For example, an advertiser can use the inventory service 404 to determine which web pages should be served with which ads. The inventory service can include estimation information that identifies which content definitions a particular content object is associate with, and embedding information that records a vector with the estimation information. An LLM query engine can interface with one or more LLM engines. For example, the LLM engines 406 can perform natural-language processing to generate the estimations by extracting and reporting the topics with which a particular document is associated. The inventory service 404 can include an embedding query engine to interface with an embedding datastore 408 that can maintain information about the universe of embedded vectors, defining a vector space. In addition, the embedding datastore can store metadata associated with the embedding universe (e.g., search indexes to allow for efficient processing of vector similarities).

The context datastore 402 can receive information about content objects from one or more datastreams. For example, a unified targets stream 414 may be generated by a web-crawler that collects information about publicly available webpages. A context materialization metadata stream 412 may be generated to decorate the unified targets stream 414 with appropriate metadata. An app estimation datastream 410 or other special-purpose datastream may be used to collect information about objects not normally available to traditional web crawlers. For example, a social-media system or application store may provide an application program interface to social-media posts or applications, respectively. A user interface can provide information to, and receive information from, one or more users.

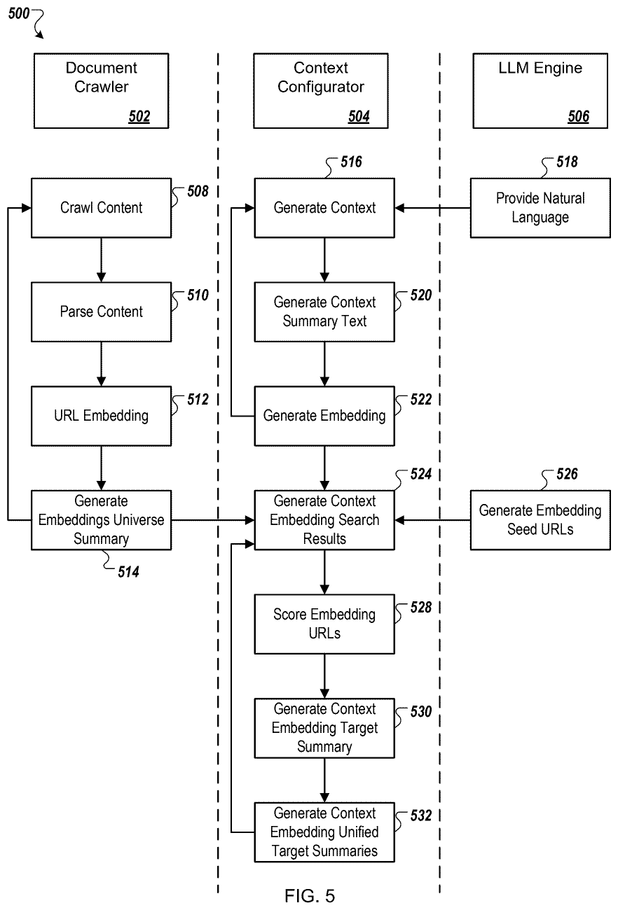

FIG. 5 shows a process 500 for generating embedding information from content objects. A document crawler 502 can operate to examine documents (e.g., web pages) in a corpus of documents (e.g., publicly available web pages that permit crawling). A context configurator 504 can generate context information for the documents examined by the document crawler 502. An LLM engine 506 can perform language operations to aid the context configuration 504.

The document crawler 502 can crawl content 508, parse the content 510, and perform URL embedding. For example, the document crawler 502 can access web pages by their URL, determine the format of the webpage, and parse the webpage to extract human-readable content. Then, the document crawler 512 can embed the human-readable content into a vector associated with that webpage.

The document crawler 502 can generate embedding universe summaries 514. For example, using a collection of the embedding vectors generated, the distribution of vectors in the vector space, empty dimensions, etc. can be determined. Then, this universe of embedded vectors can be made available to the context configurator to search against.

The context configurator 504 can generate a context, e.g., based on user input. For example, a user can supply freeform text. The context configurator 504 can use the LLM engine 506 to provide 518 natural language alternatives to the freeform text to generate 520 a group of descriptions based on the user's single entered text. The context configurator 504 can then generate 522 an embedding of the summary text by generating a vector in the same vector space as used by the document crawler 502.

The context configurator 504 can use the generated embedding to search within the embedding universe summary to generate 524 search results. For example, the context configurator 504 can find the most similar (or least dissimilar) documents crawled by performing similarity (or distance) calculations between the embedding for the context summary and the vectors created by the document crawler.

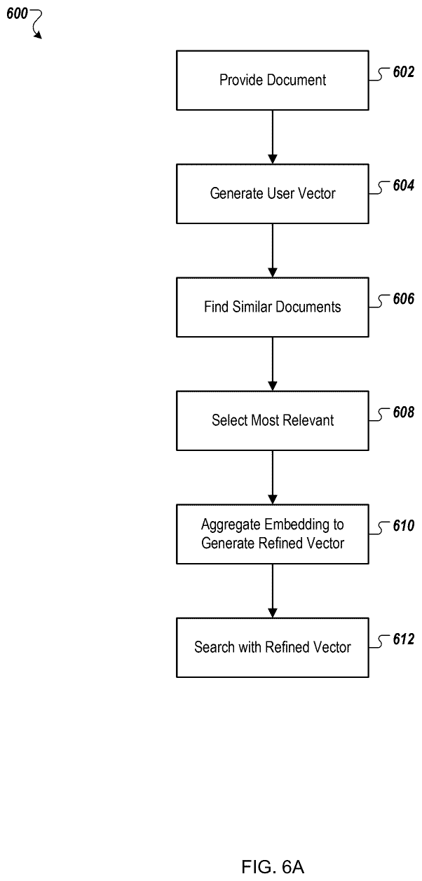

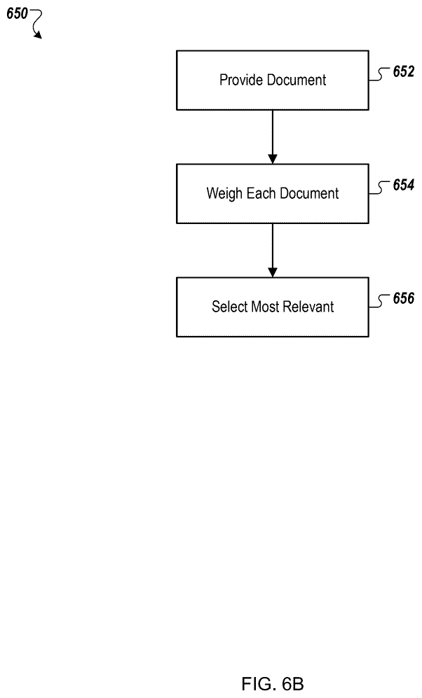

The LLM engine 506 can generate seed URLs 526. Two example operations for generating seed URLs are described later with respect to FIG. 6.

The context configurator 504 can score the embedding URLs 528. For example, the similarity (or distance) for each search result can be found and used to create a score for the search result. In some instances, the similarity (or distance) may be used directly. In some instances, the similarity (or distance) can be converted into an ordinal ranking. In some instances, the similarity (or distance) can be normalized (e.g., to a scale of 0 to 1 or 1 to 100).

The context configurator 504 can generate context embedding target summaries 530. For example, the context configurator 504 can take the scored URLs and transforms those records into the entries that will end up in targeting lists (i.e. by applying score thresholding and getting the data into the proper schema).

The context configurator 504 can generate unified target summaries 532. For example, the context configurator 504 can use web targets and the mobile app targets and combines them together into a single dataset after being processed in separate workflows.

FIGS. 6A and 6B show a processes 600 and 650 for generating seed URLs. In some instances, the process 600 can be used to generate a first set of seed URLs. If it is determined that the process 600 does not produce enough seed URLs, the process 650 can be used to produce more seed URLs. In general, the process 600 involves analysis of context of documents that have been served to be evaluated by an large language model for relevancy to the target context description. If these documents score highly on the relevancy, they become eligible to become seed URLs. In the process 650 top search results become eligible to be seed URLs. The process 650 can be performed free of the use of a large language model, and instead may be based on a e.g., a cosine similarity score (or another similarity metric) between the universe of all web embeddings and the target context embedding.

A computer system can provide documents 602. For example, a document served by the computer system (e.g., in the process 500) can be referenced by and address such as a URL. Then, the computer system can generate a user vector 604. For example, the document referenced by the URL can be analyzed to create an embedding vector.

The computer system can find similar documents 606. For example, a collection of other document embeddings can be searched to find a plurality of documents that are similar (e.g., within a threshold similarity or less than a threshold difference between the vectors). These similar documents may each be referenced by an address such as a URL.

The computer system can select a plurality of the similar document as relevant documents 608. For example, a given number of search results may be identified as relevant documents. Then, the computer system can aggregate embeddings of the selected documents to generate a refined search vector 610. For example, the computer system can create an average of the embedding vector for each of the relevant documents to find an average vector. This average vector can be used as a search vector.

The computer system can search for seed URLs with the refined search vector 612. For example, one or more additional document can be found that are similar (e.g., within a threshold similarity or less than a threshold difference between the vectors). These search results can be used as seed URLs.

A computer system can provide documents 652. For example, a document served by the computer system (e.g., in the process 500) can be referenced by and address such as a URL. Then, the computer system can weigh each of those documents 654. For example, the document referenced by the URL can be analyzed using a similarity score or difference score, by number of views, by an impression count, or by another metric or compilation of metrics.

The most relevant documents are selected 656. For example, the documents with the highest weighting my be selected. In some implementations, the computer system may limit the selection to avoid redundant or similar documents. In one example, the computer system may select only one document per domain it the URL domain space.

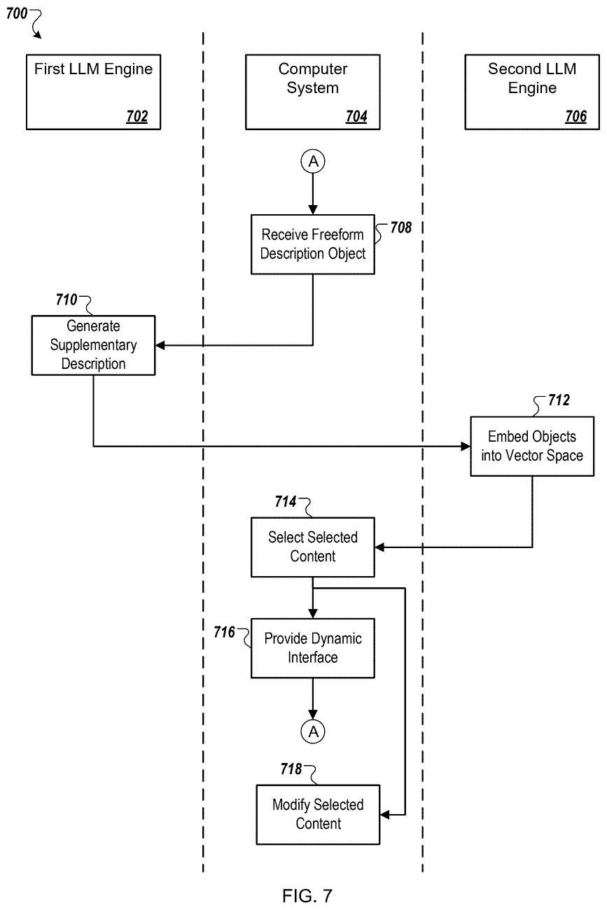

FIG. 7 shows a process 700 for identifying content matching a context. For example, the process 700 can be performed to allow a user to enter a freeform text description of content and respond to the user with real content items that have been determined to match the freeform text description. If the user receives real content that is not exactly what they are looking for, the user can dynamically edit the description until the dynamically updating results match their expectations. With that result, the user can be confident that their description can be used to provide their content along with the real content objects. For example, by placing ads (i.e., their content) in appropriate and relevant webpages (i.e. the real content items and other, similar, content items).

The process 700 can be performed by a first LLM engine 702, a computer system 704, and a second LLM engine 706. As will be appreciated, the first LLM engine 702, a computer system 704, and a second LLM engine 706 can be hosted on the same computing hardware, split between different hardware systems, owned by the same entity, owned by different entities, etc.

In some implementations, the first LLM engine 702 can be configured for speed, while the second LLM engine 706 can be configured to be slower, but less expense to operate (e.g., in terms of computing resources, financial cost, latency). For example, the first LLM engine 702 may be larger than the second LLM engine 706. For example, the second LLM engine 706 may be smaller than the first LLM engine 702.

The computer system 704 receives a data object comprising a freeform text description of desired content 708. For example, a user can access a graphical user interface (GUI) and type their input into the GUI in the form of freeform text. For example, the user may decide they wish to get results for webpages related to a particular consumer product (e.g., electric lawnmowers) and they may want to target a particular niche of that consumer product (e.g., battery operated and self-propelled). They can provide input describing that product and niche in freeform text (e.g., “new residential, electric, lawnmowers that have a battery and have a self-propelled feature”). If the results match their expectations, the user can place an order to display their advertisement for their product (e.g., batteries compatible with lawnmowers, and with large capacities that are particularly useful for self-propelled lawnmowers that use more energy).

The first LLM engine 702 creates supplementary data objects comprising other freeform text data representing the desired content using a first language model 710. For example, the computer system 704 can provide a first prompt to the first LLM engine 702 with a request to restate the user's freeform text in different styles (e.g., replacing uncommon words with more common synonyms, rephrasing the freeform text into other sentence structures, matching jargon used by different demographic groups). For example, the first prompt provided by the computer system 704 can include i) the user's freeform text, ii) a rewriting instruction to rewrite the user's freeform text, and iii) a formatting instruction specifying a textual format that the response to the first prompt should conform to.

The second LLM engine 706 embeds the data object and the supplementary data objects into a vector space using a second language model 712. For example, the computer system 704 can provide, to the second LLM engine 706, a second prompt to embed, into a vector space, the user's freeform text and the supplementary data objects (i.e. the other text created by the first LLM engine 702). The vector space can have dimensions (e.g., thousands of dimensions) that each correspond to different topics. In some implementations, this vector space can be defined by processing corpuses of data to extract semantic information and group the semantic information into different topics. Then, these topics can be used for the dimensions of the vector space.

The second prompt provided by the computer system 704 can include i) an identity instruction, ii) a first task instruction for identifying a focus a data object, iii) a second task instruction for determining if the focus for the data object aligns with a dimension of the vector space, and iv) a result instruction to format output of the result to include machine-readable values. For example, the identity instruction can instruct the second LLM engine 706 to operate as if it were an expert at parsing and identifying topics in documents. For example, the first task instruction can instruct the second LLM engine 706 to parse a data object (e.g., a webpage, a social media post) and identify the topics in the data object. For example, the second task instruction can instruct the second LLM engine 706 to determine if the topic or topics of the document match any of the dimensions of the vector space. For example, the result instruction can instruct the second LLM engine 706 to identify which, if any, of the dimensions of the vector space match the topics identified. In some instances, this identification can be a list of matching dimensions. In some instances, this identification can include a list of confidences recording how well the data object matches dimensions (e.g., the N highest confidence values) according to the processing of the second LLM engine 706.

The computer system 704 selects, from a plurality of potential content objects, selected content objects based on a similarity in the vector space between i) the selected content objects and ii) at least one of the data object and the supplementary data objects 714. For example, the computer system 704 can perform similarity calculations between the vectors in the vector space. Any vectors sufficiently similar (e.g., with a similarity score below a threshold value, the N lowest distances) can be selected.

In some instances the computer system 704 can block or detarget some of the potential content objects. For example, blocked content objects can be prevented from ever matching a given freeform description provided by the user, while detargeted content objects can instead be deprioritiesed but not completely blocked.

Blocking can be used, for example, by users that never want to find or match particular content objects. Consider, for example, an advertiser of a non-controversial consumer product (e.g., bandages). Knowing that there may be some controversial or brand-unsafe content related to the use of the consumer product (e.g., violence), and wishing only to be associated with benign uses of the consumer product (e.g., a parent tending to a child with a minor injury), the process 700 can allow the user to mark brand-unsafe topics (e.g., the previously-mentioned violence). Then, no matter how similar to the user's freeform description, the process 700 will prevent any content objects related to the brand-unsafe topic (violence) from being a match for the user's freeform description.

On the other hand, the user may wish to deemphasize, but not completely eliminate, some topics. For example, the user may have a consumer product aimed at a particular market segment (e.g., parents of young children likely to get scrapes on the playground) and deemphasize other market segments (e.g., medical professionals that see injured patients). The user can then enter a freeform description focusing on their target (e.g., “parents taking care of children who have a small injury”) and enter input specifying a detargeting of the other market segment (e.g., “medical professionals”).

When determining the similarity between the vectors, the computer system 704 can then penalize the similarity score for any content object matching the detargeting criteria. For example, the similarity score may be multiplied by a scaling factor (e.g., 0.5, 0.1). As such, the detargeted content objects are not completely eliminated, but are instead made lower priority than other content objects that might not otherwise be matched. As another example, a producer of non-meat animal products (e.g., honey, leather goods) may wish to block content objects associated with veganism (which generally refrains from any animal products) and deemphasize vegetarianism (which generally only refrains from meat, but may be less likely to use other animal products than the rest of the population).

In some instances, the vector space may include dimensions that not only identify a topic, but also have an associated mood, sentiment, or mindset. For example, one dimension may be associated with a topic (e.g., “pets”), and then further dimensions for that topic can include different moods (e.g., “sad” and “funny”). In this way, documents that may be associated with the same topic (e.g., “pets”) but with very different emotional or human impact (e.g., funny photos of cats vs sad stories about sick family dogs) can be differentiated and analyzed.

The computer system 704 provides a dynamic interface 716. For example, the computer system 704 can render a GUI for the user that allows the user to enter their freeform description, and then show a dynamically generated list of example data objects that match the entered freeform description. Responsive to the user editing their input, the dynamically generated list of example data objects can be changed by the computer system 704 based on the new version of the input.

For example, a user can modify their freeform description by removing some text, adding some new text, or altering existing text. In addition, the GUI can allow the user to specify blocked and detargeted text. This blocked and detargeted text can be received through specific text fields separate from the freeform text input, or can be extracted from the freeform text (e.g., “Content about food products, but fewer vegetarian and no vegan results” can be parsed as having “vegetarian” as a detargeted term and “vegan” as a blocked term).

To assist the user in developing their freeform text input, the GUI can provide template or canned context examples that the user can edit. For example, as the user begins and types “shoes” into the GUI, the GUI can return a canned context related to footwear (e.g., “shoes, shoelaces, sneakers, boots worn by groups of people getting along”). The user can then read this canned response and may have an easier time editing this canned response to their preferred target (e.g., “basketball sneakers worn by trendy young adults” or “Hiking-boots and trail-running shoes worn by a single person in lush wilderness backdrops” or “stylish glamor images of well dressed men in suits and polished leather shoes”).

The computer system 704 modifies selected content 718. For example, after settling on a freeform description that produces results that the user is happy with, the user may instruct the computer system 704 to use the freeform description for another operation.

For example, the computer system 704 can modify the selected content objects responsive to selecting the selected content objects. For example, the user may enter information for an advertising purchase, and the computer system 704 can insert advertisements into webpages in response to publisher requests for advertisements. For example, the computer system 704 can generate a list of recommended videos or songs to play after the user finishes watching a video or listening to a song. For example, the a retailer website may suggest an alternative product in place of product requested by a user that is out-of-stock.

In some implementations, the content objects may be installable-applications including, but not limited to, video games. In such instances, the computer system 704 may process documents associated with the installable-application. These documents can include websites on an online store for the applications, publisher information associated with the installable-applications, etc. Then, when it is time to modify the content object, the computer system 704 can serve content (e.g. an advertisement) to be displayed inside the game's interface when the user is playing the game.

What is claimed is:

1. A system for identifying content based on natural language processing, the system comprising at least one processor and memory, the memory storing instructions to cause the at least one processor to perform operations comprising:
receiving a data object comprising a freeform text description of desired content;
creating supplementary data objects comprising other freeform text data representing the desired content using a first language model;
embedding the data object and the supplementary data objects into a vector space using a second language model;
selecting, from a plurality of potential content objects, selected content objects based on a similarity in the vector space between i) the selected content objects and ii) at least one of the data object and the supplementary data objects.

2. The system of claim 1, wherein the second language model is smaller than the first language model.

3. The system of claim 1, wherein the first language model is selected to have less than a threshold amount of latency in response to user input, and wherein the second language model is larger than the first language model.

4. The system of claim 1, wherein the operations further comprise modifying the selected content objects responsive to selecting the selected content objects.

5. The system of claim 4, wherein modifying the selected content objects comprises including inclusion data related to the freeform text description.

6. The system of claim 5, wherein the inclusion data comprises an advertisement to be displayed along with the selected data objects.

7. The system of claim 1, wherein the operations further comprise:
identifying a first subset of the plurality of potential content objects as blocked objects; and
identifying a second subset of the plurality of potential content objects as detargeted objects; and
wherein selecting, from a plurality of potential content objects, selected content objects comprises:
excluding the blocked content objects; and
reducing similarities in the vector space between i) the detargeted content objects and ii) at least one of the data object and the supplementary data objects.

8. The system of claim 1, wherein:
at least some of the content objects comprise i) an installable-application, and ii) pages associated with installable-applications in a distribution system configured to distribute the installable-application.

9. The system of claim 1, wherein the vector space comprises first dimensions associated with semantic topics and second dimensions associated with sentiments for the semantic topics.

10. The system of claim 1, wherein embedding the data object and the supplementary data objects into a vector space using a second language model comprises:
providing, to the second language model, a prompt that comprises i) an identity instruction, ii) a first task instruction for identifying a focus a data object, iii) a second task instruction for determining if the focus for the data object aligns with a dimension of the vector space, and iv) a result instruction to format output of the result to include machine-readable values.

11. A method for identifying content based on natural language processing, the method comprising:
receiving a data object comprising a freeform text description of desired content;
creating supplementary data objects comprising other freeform text data representing the desired content using a first language model;
embedding the data object and the supplementary data objects into a vector space using a second language model;
selecting, from a plurality of potential content objects, selected content objects based on a similarity in the vector space between i) the selected content objects and ii) at least one of the data object and the supplementary data objects.

12. The method of claim 11, wherein the second language model is smaller than the first language model.

13. The method of claim 11, wherein the first language model is selected to have less than a threshold amount of latency in response to user input, and wherein the second language model is larger than the first language model.

14. The method of claim 11, wherein the operations further comprise modifying the selected content objects responsive to selecting the selected content objects.

15. The method of claim 11, wherein modifying the selected content objects comprises including inclusion data related to the freeform text description.

16. The method of claim 11, wherein the operations further comprise:
identifying a first subset of the plurality of potential content objects as blocked objects; and
identifying a second subset of the plurality of potential content objects as detargeted objects; and
wherein selecting, from a plurality of potential content objects, selected content objects comprises:
excluding the blocked content objects; and
reducing similarities in the vector space between i) the detargeted content objects and ii) at least one of the data object and the supplementary data objects.

17. The method of claim 11, wherein:
at least some of the content objects comprise i) an installable-application, and ii) pages associated with installable-applications in a distribution system configured to distribute the installable-application.

18. The method of claim 11, wherein the vector space comprises first dimensions associated with semantic topics and second dimensions associated with sentiments for the semantic topics.

19. The method of claim 11, wherein embedding the data object and the supplementary data objects into a vector space using a second language model comprises:
providing, to the second language model, a prompt that comprises i) an identity instruction, ii) a first task instruction for identifying a focus a data object, iii) a second task instruction for determining if the focus for the data object aligns with a dimension of the vector space, and iv) a result instruction to format output of the result to include machine-readable values.

20. A non-transitory computer readable media tangibly storing instruction that, when executed by one or more processors, cause the one or more processors to perform operations comprising:
receiving a data object comprising a freeform text description of desired content;
creating supplementary data objects comprising other freeform text data representing the desired content using a first language model;
embedding the data object and the supplementary data objects into a vector space using a second language model;
selecting, from a plurality of potential content objects, selected content objects based on a similarity in the vector space between i) the selected content objects and ii) at least one of the data object and the supplementary data objects.
